(19) United States
(12) Patent Application Publication
(10) Pub. No.: US 2025/0071650 A1
(43) Pub. Date: Feb. 27, 2025

(54) DETECTION METHOD AND APPARATUS, AND TERMINAL AND STORAGE MEDIUM

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventor: Xiaodong XU, Beijing (CN)

(21) Appl. No.: 18/722,619

(22) PCT Filed: Dec. 21, 2022
(86) PCT No.: PCT/CN2022/140630

§ 371 Date: Jun. 21, 2024

(30) Foreign Application Priority Data
Dec. 22, 2021 (CN) 202111581846.5

(51) Int. Cl. H04W 36/30; H04W 36/00

(52) U.S. Cl. CPC H04W 36/304; H04W 36/0085

(57) ABSTRACT

Disclosed in the present application are a detection method and apparatus, and a terminal and a storage medium. The method comprises: performing measurement on the signal quality or strength of a serving cell, wherein the measurement comprises measurement based on a first signal or channel, and measurement based on an inherent measurement resource, and at least one transmission signal or channel of the first signal or channel has a correspondence with at least one transmission signal or channel of the inherent measurement resource; when a detection result of at least one signal or channel in the at least one transmission signal or channel of the first signal or channel satisfies a first condition, selecting, from transmission signals or channels of the first signal or channel, a transmission signal or channel having the optimal signal quality or strength, and taking same as a detection target; and when the detection result of the at least one signal or channel of the first signal or channel does not satisfy the first condition, performing cell residence and/or selecting a target transmission signal or channel for the inherent measurement resource by means of measuring at least one transmission signal or channel for the inherent measurement resource.

### CROSS-REFERENCE TO RELATED APPLICATION

This application is based on and claims priority to Chinese patent Application No. 202111581846.5 filed on Dec. 22, 2021, the contents of which are hereby incorporated by reference in its entirety.

### TECHNICAL FIELD

The disclosure relates to the field of wireless communications, and in particular to a method and apparatus for detection, a terminal and a storage medium.

### BACKGROUND

At present, a terminal, though is dormant, still needs to be prepared to measure or detect some channels or signals in a present system on a periodic basis. Although power consumption of the terminal is improved in such a state, the power consumption is still several orders of magnitude higher than that in the state that there is no need to make preparation for reception in advance. Therefore, the terminal monitors, by an assistance module, whether there is a power of a specific signal (which may be referred to as a “wake-up signal”) from a network side to determine whether there is a signal to be sent to the terminal subsequently. If a signal power reaches a certain requirement, a communication module of the terminal is instructed to wake up. However, limited by factors such as a transmission power of the specific signal and factors such as a receiver sensitivity of the assistance module, it cannot be guaranteed that the specific signal is consistent with cell coverage in a mobile communication system (such as the fourth generation mobile communication technology (4G) or the fifth generation mobile communication technology (5G)). The inconsistency will cause that the terminal may not be able to detect the specific signal at all even if the specific signal has been sent by the network side. When the power is not detected, the terminal cannot distinguish the case that the specific signal is not transmitted by the network from the case that the specific signal is transmitted by the network but has insufficient coverage; that is, a problem of ambiguity arises. In order to solve the ambiguity problem, in related technologies, another periodically transmitted signal (which can be called a “keep-active signal”) is introduced as a priori signal, which is used to help the assistance module to distinguish whether the failure in power detection at present is resulted from that the network does not transmit the specific signal, or is a result of insufficient coverage of the specific signal. However, in such a case, the terminal needs to detect two signals, increasing the complexity in system design.

### SUMMARY

In order to solve the relevant technical problem, embodiments of the disclosure provide a method and apparatus for detection, a terminal and a storage medium.

The technical solution of the embodiments of the disclosure is implemented as follows.

The embodiments of the disclosure provide a method for detection, applied to a terminal and includes operations as follows.

Signal qualities or signal strengths of a current serving cell are measured in a cell selected to camp on after completing cell selection or reselection in cells configured with a first signal or channel. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell. In a case that a detection result of at least one transmission signal or channel in the at least one transmission signal or channel of the first signal or channel meets a first condition, a transmission signal or channel with the best signal quality or the best signal strength is selected from the at least one transmission signal or channel of the first signal or channel as a detection target. In a case that a detection result of none of the at least one transmission signal or channel of the first signal or channel meets the first condition, cell camping is performed, and/or a target transmission signal or channel of the inherent measurement resource is screened out by measuring the at least one transmission signal or channel of the inherent measurement resource of the serving cell.

The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold.

In the above solution, the inherent measurement resource includes signals and/or channels that are usable for measurement of the terminal and have to be sent when a network side is capable of providing a service for the terminal.

In the above solution, the inherent measurement resource includes one of: a reference signal for synchronization in a system; a reference signal and/or channel for synchronization and primary system information indication in the system; or a reference signal configured by the system and usable for idle-state measurement.

In the above solution, one of the at least one transmission signal or channel of the first signal or channel has a Quasi Co-Location (QCL) relationship with at least one of the at least one transmission signal or channel of the inherent measurement resource.

In the above solution, the first signal or channel is used for the terminal to perform detection after camping on a cell and to determine, based on a detection result, whether subsequent monitoring or detection for transmission signals or channels of an inherent measurement resource of the cell camped on, and/or subsequent detection or monitoring for a scheduling signal are needed.

In the above solution, tin a case that at least one transmission signal or channel in the at least one transmission signal or channel of the first signal or channel meets the first condition, detection for any transmission signal or channel of the inherent measurement resource, and/or the detection or monitoring for the scheduling signal are not needed; or in a case that none of the at least one transmission signal or channel of the first signal or channel meets the first condition, the detection for the transmission signals or channels of the inherent transmission resource, screening for the at least one transmission signal or channel of the inherent measurement resource, and/or the detection or monitoring for the scheduling signal are needed.

In the above solution, in a case that a received signal strength of the selected transmission signal or channel does not meet a third threshold and/or a received signal quality of the selected transmission signal or channel does not meet a fourth threshold, detection or monitoring for at least one transmission signal or channel corresponding to the inherent measurement resource, and/or the detection or monitoring for the scheduling signal are needed, and detection for at least one transmission signal or channel of the first signal of the serving cell is not needed; or in a case that the received signal strength of the selected transmission signal or channel meets a fifth threshold and/or the received signal quality of the selected transmission signal or channel meets a sixth threshold, a transmission signal or channel of the first signal corresponding to a transmission signal or channel of the inherent measurement resource of the serving cell is detected, and it is determined, based on a detection result, whether detection or monitoring for transmission signals or channels of the inherent transmission resource of the serving cell, and/or the detection or monitoring for the scheduling signal are needed.

In the above solution, the third threshold is same as or different from the fifth threshold; and/or the fourth threshold is same as or different from the sixth threshold.

The embodiments of the disclosure further provide a method for detection, applied to a first terminal and includes operations as follows.

Terminal selection is completed and it is selected to monitor a second terminal. Signal qualities or signal strengths of the second terminal are measured upon receiving first information from the second terminal. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one transmission signal or channel of the inherent measurement resource of the second terminal. In a case that a detection result of at least one transmission signal or channel in the at least one transmission signal or channel of the second signal or channel meets a second condition, a transmission signal or channel with the best signal quality or the best signal strength is selected from the at least one transmission signal or channel of the second signal or channel as a detection target. In a case that a detection result of none of the at least one transmission signal or channel of the first signal or channel meets the second condition, a target transmission signal or channel of the inherent measurement resource is screened out by measuring the at least one transmission signal or channel of the inherent measurement resource of the second terminal.

The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold.

In the above solution, the inherent measurement resource includes one of: a reference signal for synchronization in a terminal-to-terminal link; a reference signal and/or channel for synchronization and primary system information indication in the terminal-to-terminal link; or a reference signal configured by the system and usable for idle-state measurement.

In the above solution, one of the at least one transmission signal or channel of the second signal or channel has a Quasi Co-Location (QCL) relationship with at least one of the at least one transmission signal or channel of the inherent measurement resource.

In the above solution, the second signal or channel is used for the first terminal to perform detection after performing terminal selection and to determine, based on a detection result, whether subsequent monitoring or detection for transmission signals or channels of an inherent measurement resource of the second terminal, and/or subsequent detection or monitoring for a scheduling signal are needed.

In the above solution, in a case that at least one transmission signal or channel in the at least one transmission signal or channel of the second signal or channel meets the second condition, detection for any transmission signal or channel of the inherent measurement resource, and/or the detection or monitoring for the scheduling signal are not needed; or in a case that none of the at least one transmission signal or channel of the second signal or channel meets the second condition, the detection for the transmission signals or channels of the inherent transmission resource, screening for the at least one transmission signal or channel of the inherent measurement resource, and/or the detection or monitoring for the scheduling signal are needed.

In the above solution, in a case that a received signal strength of the selected transmission signal or channel does not meet a ninth threshold and/or a received signal quality of the selected transmission signal or channel does not meet a tenth threshold, detection or monitoring for at least one transmission signal or channel corresponding to the inherent measurement resource of the second terminal, and/or the detection or monitoring for the scheduling signal are needed, and detection for the at least one transmission signal or channel of the second signal of the second terminal is not needed; or in a case that the received signal strength of the selected transmission signal or channel meets an eleventh threshold and/or the received signal quality of the selected transmission signal or channel meets a twelfth threshold, a transmission signal or channel of the second signal corresponding to a transmission signal or channel of the inherent measurement resource of the second terminal is detected, and it is determined, based on a detection result, whether detection or monitoring for transmission signals or channels of the inherent transmission resource of the second terminal, and/or the detection or monitoring for the scheduling signal are needed.

In the above solution, the ninth threshold is same as or different from the eleventh threshold; and/or the tenth threshold is same as or different from the twelfth threshold.

The embodiments of the disclosure further provide an apparatus for detection and include a first measurement unit and a first processing unit.

The first measurement unit is configured to measure, in a cell selected to camp on by a terminal after completing cell selection or reselection in cells configured with a first signal or channel, signal qualities or signal strengths of a current serving cell. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell.

The first processing unit is configured to: in a case that a detection result of at least one transmission signal or channel in the at least one transmission signal or channel of the first signal or channel meets a first condition, select, from the at least one transmission signal or channel of the first signal or channel, a transmission signal or channel with the best signal quality or the best signal strength as a detection target. The first processing unit is configured to: in a case that a detection result of none of the at least one transmission signal or channel of the first signal or channel meets the first condition, perform cell camping and/or screen out a target transmission signal or channel of the inherent measurement resource by measuring the at least one transmission signal or channel of the inherent measurement resource of the serving cell. The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold.

The embodiments of the disclosure further provide an apparatus for detection and include a monitoring unit, a second measurement unit and a second processing unit.

The monitoring unit is configured to complete terminal selection and select to monitor a second terminal.

The second measurement unit is configured to measure signal qualities or signal strengths of the second terminal upon receiving first information from the second terminal. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one different transmission signal or channel of the inherent measurement resource of the second terminal.

The second processing unit is configured to: in a case that a detection result of at least one transmission signal or channel in the at least one transmission signal or channel of the second signal or channel meets a second condition, select, from the at least one transmission signal or channel of the second signal or channel, a transmission signal or channel with the best signal quality or the best signal strength as a detection target; and in a case that a detection result of none of the at least one transmission signal or channel of the first signal or channel meets the second condition, screen out a target transmission signal or channel of the inherent measurement resource by measuring the at least one transmission signal or channel of the inherent measurement resource of the second terminal. The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold.

The embodiments of the disclosure further provide a terminal, including a processor and a communication interface.

The processor is configured to measure, in a cell selected to camp on by the terminal after completing cell selection or reselection in cells configured with a first signal or channel, signal qualities or signal strengths of a current serving cell. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell. The processor is configured to: in a case that a detection result of at least one transmission signal or channel in the at least one transmission signal or channel of the first signal or channel meets a first condition, select, from the at least one transmission signal or channel of the first signal or channel, a transmission signal or channel with the best signal quality or the best signal strength as a detection target. The processor is configured to: in a case that a detection result of none of the at least one transmission signal or channel of the first signal or channel meets the first condition, perform cell camping and/or screen out a target transmission signal or channel of the inherent measurement resource by measuring the at least one transmission signal or channel of the inherent measurement resource of the serving cell. The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold.

Alternatively, the processor is configured to: complete terminal selection and selects to monitor a second terminal; measure signal qualities or signal strengths of the second terminal upon receiving first information from the second terminal through the communication interface. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one different transmission signal or channel of the inherent measurement resource of the second terminal. The processor is configured to: in a case that a detection result of at least one transmission signal or channel in the at least one transmission signal or channel of the second signal or channel meets a second condition, select, from the at least one transmission signal or channel of the second signal or channel, a transmission signal or channel with the best signal quality or the best signal strength as a detection target. The processor is configured to: in a case that a detection result of none of the at least one transmission signal or channel of the first signal or channel meets the second condition, screen out a target transmission signal or channel of the inherent measurement resource by measuring the at least one transmission signal or channel of the inherent measurement resource of the second terminal. The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold.

The embodiments of the disclosure further provide a terminal, including a processor and a memory for storing a computer program executable by the processor. The processor is configured to run the computer program to implement operations of any above method.

The embodiments of the disclosure further provide a storage medium having stored thereon a computer program that, when executed by a processor, implements operations of any above method.

According to the method and apparatus for detection, the terminal and the storage medium provided in the embodiments of the disclosure, a terminal measures, in a cell selected to camp on after completing cell selection or reselection in cells configured with a first signal or channel, signal qualities or signal strengths of a current serving cell. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell. In a case that a detection result of at least one transmission signal or channel in the at least one transmission signal or channel of the first signal or channel meets a first condition, a transmission signal or channel with the best signal quality or the best signal strength is select from the at least one transmission signal or channel of the first signal or channel as a detection target. In a case that a detection result of none of the at least one transmission signal or channel of the first signal or channel meets the first condition, at least one of following is performed by measuring the at least one transmission signal or channel of the inherent measurement resource of the serving cell: cell camping, or screening out a target transmission signal or channel of the inherent measurement resource.

The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold. In the solution provided by the embodiments of the disclosure, a network side sends a signal or channel. For a dormant terminal, the signal or channel has both the function of keep alive and the function of wake up, so that the terminal only needs to detect this one signal, and determines, based on a correspondence between the signal and an inherent measurement resource, when the terminal needs to determine an operating state based on the inherent measurement resource, and when the terminal needs to determine the operating state based on the signal, thus greatly reducing the complexity of system design. Furthermore, terminal selection is completed and it is selected to monitor a second terminal. A first terminal measures signal qualities or signal strengths of the second terminal upon receiving first information from the second terminal. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one transmission signal or channel of the inherent measurement resource of the second terminal. In a case that a detection result of at least one transmission signal or channel in the at least one transmission signal or channel of the second signal or channel meets a second condition, a transmission signal or channel with the best signal quality or the best signal strength is selected from the at least one transmission signal or channel of the second signal or channel as a detection target. In a case that a detection result of none of the at least one transmission signal or channel of the first signal or channel meets the second condition, a target transmission signal or channel of the inherent measurement resource is screened out by measuring the at least one transmission signal or channel of the inherent measurement resource of the second terminal. The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold. In the solution provided by the embodiments of the disclosure, a terminal sends a signal or channel. For a dormant receiving terminal, the signal or channel has both the function of keep alive and the function of wake up, so that the receiving terminal only needs to detect this one signal, and determines, based on a correspondence between the signal and an inherent measurement resource, when the terminal needs to determine an operating state based on the inherent measurement resource, and when the terminal needs to determine the operating state based on the signal, thus greatly reducing the complexity of system design.

### BRIEF DESCRIPTION OF THE DRAWINGS

FIG. 1 illustrates a schematic flowchart of a method for detection according to an embodiment of the disclosure.

FIG. 2 illustrates a schematic diagram of another method for detection according to an embodiment of the disclosure.

FIG. 3 illustrates a schematic structural diagram of an apparatus for detection according to an embodiment of the disclosure.

FIG. 4 illustrates a schematic structural diagram of another apparatus for detection according to an embodiment of the disclosure.

FIG. 5 illustrates a schematic structural diagram of a terminal according to an embodiment of the disclosure.

### DETAILED DESCRIPTION

The disclosure is further described in detail in conjunction with the drawings and embodiments.

In related art, an assistance module of a terminal decides, by monitoring existence of a power of the wake-up signal, whether there is a signal to be sent to the terminal subsequently. When a signal power exists, the assistance module instructs a communication module of the terminal to wake up to perform corresponding operations. Specifically, in an idle state, cell selection/reselection or paging monitoring may be performed. In a connected state, detection for a signal or channel assisted by the wake-up signal, such as a Physical Downlink Control Channel (PDCCH) in an active duration, may be performed. When there is no signal power, the terminal maintains dormant or in a node state, ignoring paging in a current paging transmission candidate location or subsequent paging transmission candidate locations, and/or ignoring detection for the PDCCH or a Physical Downlink Shared Channel (PDSCH).

On the other hand, the assistance module of the terminal further determines, through the power detection for the keep-alive signal, whether the terminal is within an effective coverage of the wake-up signal, that is, whether the wake-up signal keeps effective. If the assistance module fails to detect the keep-alive signal or detects that the power of the keep-alive signal is lower than a certain threshold, it is considered that the terminal is not within the effective coverage of the wake-up signal, and the assistance module notifies the communication module of the terminal to resume the cell reselection procedure in a normal idle state or to normally monitor paging according to a normal paging cycle, or to normally monitor the PDCCH, and that paging in any paging cycle can no longer be ignored, or any PDCCH in the PDCCH candidate locations that should belong to the active duration of the terminal according to a network side configuration can no longer be ignored. If the assistance module detects the keep-alive signal or detects that the power of the keep-alive signal is not lower than a certain threshold, it indicates that the wake-up signal keeps alive.

It can be seen from the above description that, in the related art, it is considered that the terminal needs to wake up if the power of the wake-up signal is detected. In order to avoid the uncertainty of behaviors of the terminal when the wake-up signal is not detected, the keep-alive signal is additionally introduced to distinguish ambiguity. The details are specifically as follows.
1) if the power of the keep-alive signal is detected and the power of the wake-up signal is detected, it indicates that the terminal needs to wake up.
2) if the power of the keep-alive signal is detected but no power of the wake-up signal is detected, it indicates that the terminal does not need to wake up.
3) if no power of the keep-alive signal is detected, it indicates that the assistance module can no longer be relied on to decide whether the terminal needs to wake up or maintain dormant.

On this basis, in various embodiments of the disclosure, a sending end (a network side, or a terminal in a sidelink (SL) scenario) sends a signal or channel (namely, there is no need to send a keep-alive signal indicating whether to keep alive and a wake-up signal for waking up respectively). For a dormant terminal, the signal or channel has both the function of keep alive and the function of wake up, so that the terminal only needs to detect this one signal, and defines, based on a correspondence between the signal and a system-inherent signal (namely, an inherent measurement resource), when the terminal needs to determine an operating state based on the system-inherent signal, and when the terminal needs to determine the operating state based on this signal, thus reducing the complexity of design.

For different sending ends sending the signal with both the keep alive function and the wake up function, the terminal employ different processing manners. The scheme of the embodiments of the disclosure will be described in detail for the different sending ends respectively.

Firstly, the scheme of the embodiments of the disclosure when the sending end includes the network side is described

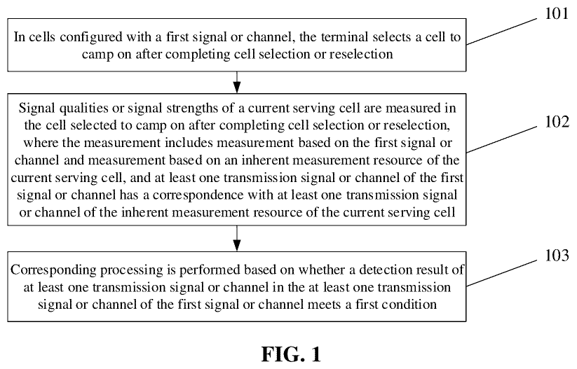

The embodiments of the disclosure provide a method for detection, applied to a terminal. As illustrated in FIG. 1, the method includes operations as follows.

Operation 101: in cells configured with a first signal or channel, the terminal selects a cell to camp on after completing cell selection or reselection.

Operation 102: signal qualities or signal strengths of a current serving cell are measured in the cell selected to camp on after completing cell selection or reselection. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell.

Operation 103: in a case that a detection result of at least one transmission signal or channel in the at least one transmission signal or channel of the first signal or channel meets a first condition, a transmission signal or channel with the best signal quality or the best signal strength is select from the at least one transmission signal or channel of the first signal or channel as a detection target. In a case that a detection result of none of the at least one transmission signal or channel of the first signal or channel meets the first condition, at least one of following is performed by measuring the at least one transmission signal or channel of the inherent measurement resource of the serving cell: cell camping, or screening out a target transmission signal or channel of the inherent measurement resource.

The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold.

In practical applications, the terminal may be referred to as User Equipment (UE), or may be referred to as a user.

At operation 101, the cell selected to camp on by the terminal is configured with the first signal or channel. Correspondingly, the current serving cell is the cell selected to camp on by the terminal.

Exemplarily, it is assumed that the first cell is configured with the first signal or channel. After the terminal completes cell selection or reselection and selects to camp on the first cell, the terminal measures signal qualities or signal strengths of the first cell. The measurement includes measurement based on the first signal or channel and measurement based on an inherent measurement resource of the first cell.

In a case that a detected power of at least one transmission signal or channel in at least one transmission signal or channel of the first signal or channel meets a first condition, the terminal selects a transmission signal or channel with the best signal quality or the best signal strength from the at least one transmission signal or channel of the first signal or channel as a detection target. In a case that a detected power of none of the at least one transmission signal or channel of the first signal or channel meets the first condition, at least one of following is performed by the at least one transmission signal or channel of the inherent measurement resource of the first cell: cell camping, and/or screening out a target transmission signal or channel of the inherent measurement resource.

In an embodiment, the inherent measurement resource includes signals and/or channels that are usable for measurement of the terminal and have to be sent when a network side is capable of providing a service for the terminal.

In particular, the inherent measurement resource includes one of: a reference signal for synchronization in a system; a reference signal and/or channel for synchronization and primary system information indication in the system; or a reference signal configured by the system and usable for idle-state measurement.

In communication systems with different standards, the name of the reference signal may be different. For example, in a 5G system, the reference signal and/or channel for synchronization and primary system information indication in the system includes a Synchronization Signal Block (SSB), which is not limited herein.

The first signal or channel is used for the terminal to perform detection after camping on a cell and to determine, based on a detection result, whether subsequent monitoring or detection for transmission signals or channels of an inherent measurement resource of the cell camped on, and/or subsequent detection or monitoring for a scheduling signal (which may also be referred to as a scheduling indication signal) are needed.

Particularly, in a case that at least one transmission signal or channel in the at least one transmission signal or channel of the first signal or channel meets the first condition, detection for any transmission signal or channel of the inherent measurement resource, and/or the detection or monitoring for the scheduling signal (for example, a PDCCH) are not needed.

Correspondingly, in a case that none of the at least one transmission signal or channel of the first signal or channel meets the first condition, the detection for the transmission signals or channels of the inherent transmission resource, screening for the at least one transmission signal or channel of the inherent measurement resource, and/or the detection or monitoring for the scheduling signal are needed.

The event that at least one transmission signal or channel of the first signal or channel has a correspondence with at least one transmission signal or channel of the inherent measurement resource of the serving cell means that: some one of the at least one transmission signal or channel of the first signal or channel has a QCL relationship with some one of at least one transmission signal or channel of the inherent measurement resource. The corresponding relationship may be one-to-one correspondence; namely, one transmission signal or channel of the first signal or channel corresponds to one transmission signal or channel of the inherent measurement resource. The corresponding relationship may also be one-to-multiple correspondence; namely, one transmission signal or channel of the first signal or channel corresponds to multiple transmission signals or channels of the inherent measurement resource. That is to say, one of the at least one transmission signal or channel of the first signal or channel has a QCL relationship with at least one transmission signal or channel of the inherent measurement resource.

Here, in practical applications, the QCL relationship may be indicated by a Transmission Configuration Indicator (TCI).

At operation 103, the terminal performs corresponding processing based on whether a detection result of at least one transmission signal or channel in the at least one transmission signal or channel of the first signal or channel meets the first condition.

In a case that a detection result of at least one transmission signal or channel in the at least one transmission signal or channel of the first signal or channel meets the first condition, it indicates that the terminal is still within the coverage of the current serving cell, and there is no need to perform cell selection or reselection. It is only needed to perform beam selection or reselection based on the first signal or channel, that is, the terminal selects a transmission signal or channel with the best signal quality or the best signal strength from the at least one transmission signal or channel of the first signal or channel as a detection target. The terminal may maintain dormant. At this time, there is no data need to be received and detected by the terminal.

Correspondingly, in a case that a detection result of none of the at least one transmission signal or channel of the first signal or channel meets the first condition, it indicates that the terminal may be not within the coverage of the current serving cell. At this time, the terminal may not continue the detection for the first signal or channel on the current beam, and it is only needed to perform cell camping and/or to screen out a target transmission signal or channel of the inherent measurement resource based on measurement of the at least one transmission signal or channel of the inherent measurement resource. Specifically, the terminal may firstly determine whether a current location of the terminal still belongs to the current serving cell based on the measurement of the at least one transmission signal or channel of the inherent measurement resource, that is, whether the terminal is still within the coverage of the current serving cell is firstly determined. When the terminal still belongs to the current serving cell, the target transmission signal or channel of the inherent measurement resource is screened out, and the terminal needs to exit the dormant state (at this time, the terminal considers that receiving and detection needs to be performed, or considers that the terminal is no longer within the coverage of the first signal or channel). If it is determined, based on the measurement of at least one transmission signal or channel of the inherent measurement resource, that the current cell signal strength at the current location of the terminal has met the cell reselection condition (for example, lower than a preset threshold), the terminal needs to perform cell reselection.

In practical applications, the first threshold refers to a detection power threshold that is indicated by the communication system and needs to be reached when the transmission signal or channel corresponding to the first signal or channel can be used as an effective reference. The first threshold may be set as required.

The second threshold refers to a detection quality (also known as detection strength) threshold that is indicated by the communication system and needs to be reached when the transmission signal or channel corresponding to the first signal or channel can be used as an effective reference. The second threshold may be set as required.

In an embodiment, when the terminal screens out the target transmission signal or channel of the inherent measurement resource by measuring the at least one transmission signal or channel of the inherent measurement resource of the serving cell: in a case that a received signal strength of the selected transmission signal or channel does not meet a third threshold and/or a received signal quality of the selected transmission signal or channel does not meet a fourth threshold, the terminal needs to detect or monitor at least one transmission signal or channel corresponding to the inherent measurement resource, and/or to detect or monitor the scheduling signal, and does not need to detect the at least one transmission signal or channel of the first signal of the serving cell.

Correspondingly, in a case that the received signal strength of the selected transmission signal or channel meets a fifth threshold and/or the received signal quality of the selected transmission signal or channel meets a sixth threshold, a transmission signal or channel of the first signal corresponding to a transmission signal or channel of the inherent measurement resource of the serving cell is detected, and it is determined, based on a detection result, whether detection or monitoring for transmission signals or channels of the inherent transmission resource of the serving cell, and/or the detection or monitoring for the scheduling signal are needed.

Through the above operations, it can be ensured that the terminal may maintain dormant when having determined that no data need to be received and detected, and it can be ensured that the communication module can be waked up in a timely manner when it is determined that the terminal is not in the serving cell or there is data need to be received and detected.

In practical applications, the third threshold may be same as or may be different from the fifth threshold. The fourth threshold may be same as or may be different from the sixth threshold. Furthermore, the third threshold, the fourth threshold, the fifth threshold and the sixth threshold may all be set as required.

For the first condition, one of the five conditions may be selected as needed when implementing the scheme of the embodiments of the disclosure.

According to the method for detection provided in the embodiments of the disclosure, a terminal measures, in a cell selected to camp on after completing cell selection or reselection in cells configured with a first signal or channel, signal qualities or signal strengths of a current serving cell. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell. In a case that a detection result of at least one transmission signal or channel in the at least one transmission signal or channel of the first signal or channel meets a first condition, a transmission signal or channel with the best signal quality or the best signal strength is select from the at least one transmission signal or channel of the first signal or channel as a detection target. In a case that a detection result of none of the at least one transmission signal or channel of the first signal or channel meets the first condition, at least one of following is performed by measuring the at least one transmission signal or channel of the inherent measurement resource of the serving cell: cell camping, or screening out a target transmission signal or channel of the inherent measurement resource. The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold. In the solution provided by the embodiments of the disclosure, a network side sends a signal or channel. For a dormant terminal, the signal or channel has both the function of keep alive and the function of wake up, so that the terminal only needs to detect this one signal, and determines, based on a correspondence between the signal and an inherent measurement resource, when the terminal needs to determine an operating state based on the inherent measurement resource, and when the terminal needs to determine the operating state based on the signal, thus greatly reducing the complexity of system design.

Next, the scheme of the embodiments of the disclosure when the sending end includes a terminal in a terminal-to-terminal link is described

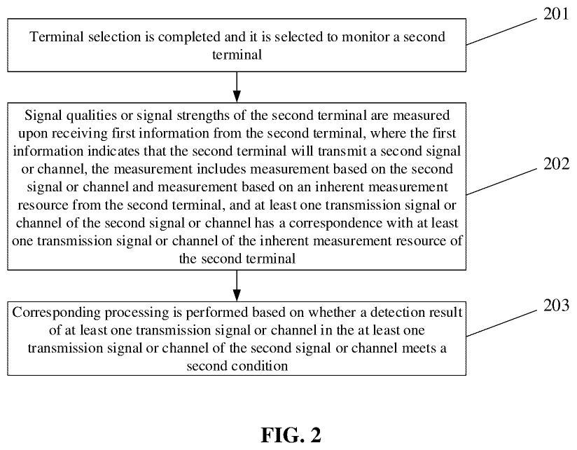

The embodiments of the disclosure further provide a method for detection, applied to a first terminal, namely applied to a terminal in a terminal-to-terminal link, namely applied to a terminal in an SL scenario. As illustrated in FIG. 2, the method includes operations as follows.

Operation 201: terminal selection is completed and it is selected to monitor a second terminal.

Operation 202: signal qualities or signal strengths of the second terminal is measured upon receiving first information from the second terminal. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one transmission signal or channel of the inherent measurement resource of the second terminal.

Operation 203: in a case that a detection result of at least one transmission signal or channel in the at least one transmission signal or channel of the second signal or channel meets a second condition, a transmission signal or channel with the best signal quality or the best signal strength is selected from the at least one transmission signal or channel of the second signal or channel as a detection target. In a case that a detection result of none of the at least one transmission signal or channel of the first signal or channel meets the second condition, a target transmission signal or channel of the inherent measurement resource is screened out by measuring the at least one transmission signal or channel of the inherent measurement resource of the second terminal.

The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold.

In practical applications, the terminal may be referred to as UE, or may be referred to as a user.

In an embodiment, the inherent measurement resource includes one of: a reference signal for synchronization in a terminal-to-terminal link, namely an SL Synchronization Signal (S-SS); a reference signal and/or channel for synchronization and primary system information indication in the terminal-to-terminal link, namely a reference signal and/or channel for synchronization and primary system information indication in the SL; or a reference signal configured by the system (namely, the network side, such as base station) and usable for idle-state measurement.

In communication systems with different standards, the name of the reference signal may be different. For example, in a 5G system, the reference signal and/or channel for synchronization and primary system information indication in the terminal-to-terminal link includes an SL SSB, which is not limited herein.

The second signal or channel is used for the first terminal to perform detection after performing terminal selection and to determine, based on a detection result, whether subsequent monitoring or detection for transmission signals or channels of an inherent measurement resource of the second terminal, and/or subsequent detection or monitoring for a scheduling signal (which may also be referred to as a scheduling indication signal) are needed.

In particular, in a case that at least one transmission signal or channel in the at least one transmission signal or channel of the second signal or channel meets the second condition, detection for any transmission signal or channel of the inherent measurement resource, and/or the detection or monitoring for the scheduling signal are not needed.

Correspondingly, in a case that none of the at least one transmission signal or channel of the second signal or channel meets the second condition, the detection for the transmission signals or channels of the inherent transmission resource, screening for the at least one transmission signal or channel of the inherent measurement resource, and/or the detection or monitoring for the scheduling signal are needed.

The event that at least one transmission signal or channel of the second signal or channel has a correspondence with at least one transmission signal or channel of the inherent measurement resource of the second terminal means that: some one of the at least one transmission signal or channel of the second signal or channel has a QCL relationship with some one of at least one transmission signal or channel of the inherent measurement resource. The corresponding relationship may be one-to-one correspondence; namely, one transmission signal or channel of the second signal or channel corresponds to one transmission signal or channel of the inherent measurement resource. The corresponding relationship may also be one-to-multiple correspondence; namely, one transmission signal or channel of the second signal or channel corresponds to multiple transmission signals or channels of the inherent measurement resource. That is to say, one of the at least one transmission signal or channel of the second signal or channel has a QCL relationship with at least one transmission signal or channel of the inherent measurement resource.

At operation 203, the first terminal performs corresponding processing based on whether a detection result of at least one transmission signal or channel in the at least one transmission signal or channel of the second signal or channel meets the second condition.

In a case that a detection result of at least one transmission signal or channel in the at least one transmission signal or channel of the second signal or channel meets the second condition, it indicates that the first terminal is still within the coverage of the second signal or channel, and selection for multiple transmission signals or channels of the inherent measurement resource is no need. It is only needed to perform selection or reselection based on the second signal or channel, that is, the first terminal selects a transmission signal or channel with the best signal quality or the best signal strength from the at least one transmission signal or channel of the second signal or channel as a detection target. The first terminal may maintain dormant. At this time, there is no data need to be received and detected by the first terminal.

Correspondingly, in a case that a detection result of none of the at least one transmission signal or channel of the second signal or channel meets the second condition, it indicates that the first terminal may be not within the coverage of the second signal or channel. At this time, the first terminal may not continue the detection for the second signal or channel on the current beam, and a target transmission signal or channel of the inherent measurement resource needs to be screened out based on measurement of the at least one transmission signal or channel of the inherent measurement resource.

In practical applications, the seventh threshold refers to a detection power threshold that is indicated by the communication system or the second terminal and needs to be reached when the transmission signal or channel corresponding to the second signal or channel can be used as an effective reference. The seventh threshold may be set as required.

The eighth threshold refers to a detection quality (also known as detection strength) threshold that is indicated by the communication system and needs to be reached when the transmission signal or channel corresponding to the second signal or channel can be used as an effective reference. The eighth threshold may be set as required.

In an embodiment, when the first terminal screens out the target transmission signal or channel of the inherent measurement resource by measuring the at least one transmission signal or channel of the inherent measurement resource of the second terminal: in a case that a received signal strength of the selected transmission signal or channel does not meet a ninth threshold and/or a received signal quality of the selected transmission signal or channel does not meet a tenth threshold, the first terminal needs to detect or monitor at least one transmission signal or channel corresponding to the inherent measurement resource of the second terminal, and/or to detect or monitor the scheduling signal, and does not need to detect the at least one transmission signal or channel of the second signal of the second terminal.

Correspondingly, in a case that the received signal strength of the selected transmission signal or channel meets an eleventh threshold and/or the received signal quality of the selected transmission signal or channel meets a twelfth threshold, a transmission signal or channel of the second signal corresponding to a transmission signal or channel of the inherent measurement resource of the second terminal is detected, and it is determined, based on a detection result, whether detection or monitoring for transmission signals or channels of the inherent transmission resource of the second terminal, and/or the detection or monitoring for the scheduling signal are needed.

Through the above operations, it can be ensured that the terminal can maintain dormant when having determined that no data need to be received and detected, and the communication module can be waked up in a timely manner when it is determined that there is data need to be received and detected.

In practical applications, the ninth threshold may be same as or may be different from the eleventh threshold. The tenth threshold may be same as or may be different from the twelfth threshold. Furthermore, the ninth threshold, the tenth threshold, the eleventh threshold and the twelfth threshold may all be set required.

In the method for detection according to the embodiments of the disclosure, terminal selection is completed and it is selected to monitor a second terminal. A first terminal measures signal qualities or signal strengths of the second terminal upon receiving first information from the second terminal. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one transmission signal or channel of the inherent measurement resource of the second terminal. In a case that a detection result of at least one transmission signal or channel in the at least one transmission signal or channel of the second signal or channel meets a second condition, a transmission signal or channel with the best signal quality or the best signal strength is selected from the at least one transmission signal or channel of the second signal or channel as a detection target. In a case that a detection result of none of the at least one transmission signal or channel of the first signal or channel meets the second condition, a target transmission signal or channel of the inherent measurement resource is screened out by measuring the at least one transmission signal or channel of the inherent measurement resource of the second terminal. The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold. In the solution provided by the embodiments of the disclosure, a terminal sends a signal or channel. For a dormant receiving terminal, the signal or channel has both the function of keep alive and the function of wake up, so that the receiving terminal only needs to detect this one signal, and determines, based on a correspondence between the signal and an inherent measurement resource, when the terminal needs to determine an operating state based on the inherent measurement resource, and when the terminal needs to determine the operating state based on the signal, thus greatly reducing power consumption of the terminal.

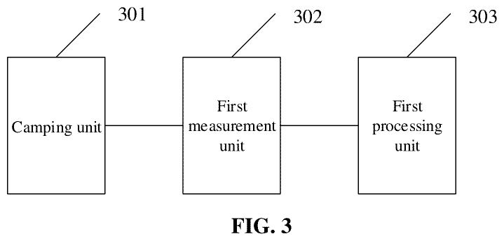

In order to implement the method according to the embodiments of the disclosure, the embodiments of the disclosure further provide an apparatus for detection, arranged on a terminal. As illustrated in FIG. 3, the apparatus includes a first measurement unit 302 and a first processing unit 303.

The first measurement unit 302 is configured to measure, in a cell selected to camp on by a terminal after completing cell selection or reselection in cells configured with a first signal or channel, signal qualities or signal strengths of a current serving cell. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell.

The first processing unit 303 is configured to: in a case that a detection result of at least one transmission signal or channel in the at least one transmission signal or channel of the first signal or channel meets a first condition, select, from the at least one transmission signal or channel of the first signal or channel, a transmission signal or channel with the best signal quality or the best signal strength as a detection target. The first processing unit is configured to: in a case that a detection result of none of the at least one transmission signal or channel of the first signal or channel meets the first condition, perform cell camping and/or screen out a target transmission signal or channel of the inherent measurement resource by measuring the at least one transmission signal or channel of the inherent measurement resource of the serving cell. The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold.

In an embodiment, as illustrated in FIG. 3, the apparatus may further include a camping unit 301.

The camping unit 301 is configured such that in cells configured with a first signal or channel, the terminal selects a cell to camp on after completing cell selection or reselection.

The first processing unit 303 is further configured to: in a case that a received signal strength of the selected transmission signal or channel does not meet a third threshold and/or a received signal quality of the selected transmission signal or channel does not meet a fourth threshold, detect or monitor at least one transmission signal or channel corresponding to the inherent measurement resource, and/or detect or monitor the scheduling signal, and not detect the at least one transmission signal or channel of the first signal of the serving cell.

Alternatively, the first processing unit 303 is further configured to: in a case that the received signal strength of the selected transmission signal or channel meets a fifth threshold and/or the received signal quality of the selected transmission signal or channel meets a sixth threshold, detect a transmission signal or channel of the first signal corresponding to a transmission signal or channel of the inherent measurement resource of the serving cell, and determine, based on a detection result, whether detection or monitoring for transmission signals or channels of the inherent transmission resource of the serving cell, and/or whether the detection or monitoring for the scheduling signal are needed.

In practical applications, the camping unit 301, the first measurement unit 302 and the second processing unit 303 may be implemented by a processor in the device for detection in conjunction with a communication interface.

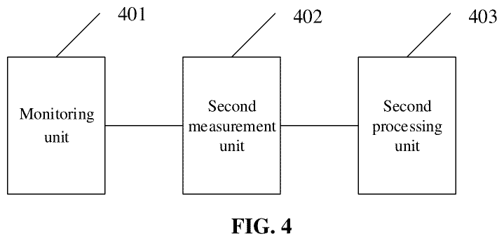

In order to implement the method according to the embodiments of the disclosure, the embodiments of the disclosure further provide an apparatus for detection, arranged on a terminal. As illustrated in FIG. 4, the apparatus includes a first measurement unit 302 and a first processing unit 303.

The monitoring unit 401 is configured to complete terminal selection and select to monitor a second terminal.

The second measurement unit 402 is configured to measure signal qualities or signal strengths of the second terminal upon receiving first information from the second terminal. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one different transmission signal or channel of the inherent measurement resource of the second terminal.

The second processing unit 403 is configured to: in a case that a detection result of at least one transmission signal or channel in the at least one transmission signal or channel of the second signal or channel meets a second condition, select, from the at least one transmission signal or channel of the second signal or channel, a transmission signal or channel with the best signal quality or the best signal strength as a detection target; and in a case that a detection result of none of the at least one transmission signal or channel of the first signal or channel meets the second condition, screen out a target transmission signal or channel of the inherent measurement resource by measuring the at least one transmission signal or channel of the inherent measurement resource of the second terminal. The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold.

In an embodiment, the second processing unit 403 is further configured to: in a case that a received signal strength of the selected transmission signal or channel does not meet a ninth threshold and/or a received signal quality of the selected transmission signal or channel does not meet a tenth threshold, detect or monitor at least one transmission signal or channel corresponding to the inherent measurement resource of the second terminal, and/or detect or monitor the scheduling signal, and not detect the at least one transmission signal or channel of the second signal of the second terminal.

Alternatively, the second processing unit 403 is further configured to: in a case that the received signal strength of the selected transmission signal or channel meets an eleventh threshold and/or the received signal quality of the selected transmission signal or channel meets a twelfth threshold, detect a transmission signal or channel of the second signal corresponding to a transmission signal or channel of the inherent measurement resource of the second terminal, and determine, based on a detection result, whether detection or monitoring for transmission signals or channels of the inherent transmission resource of the second terminal, and/or the detection or monitoring for the scheduling signal are needed.

In practical applications, the monitoring unit 401, the second measurement unit 402 and the second processing unit 403 may be implemented by a processor in the device for detection in conjunction with a communication interface.

It is to be noted that for the above apparatus for detection according to the embodiments, the division of the program modules above is used as an example for description of the detection only. In practical applications, the processing may be allocated to and accomplished by different program modules according to demands. Namely, the inner structure of the apparatus may be divided into different program modules to accomplish all or part of the processing described above. Additionally, the above apparatus for detection according to the embodiments belong to the same concept as the method for detection, and details of the particular implementation process of the apparatus may refer to the method embodiments, which will not be described here again.

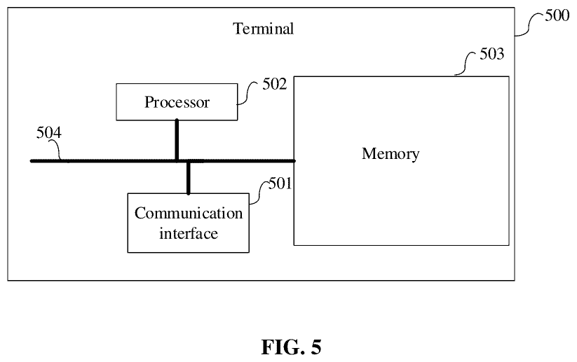

Based on the hardware implementation of the above program modules, and in order to implement the method according to the embodiments of the disclosure, the embodiments of the disclosure further provide a terminal. As illustrated in FIG. 5, the terminal 500 includes a communication interface 501, a processor 502 and a memory 503.

The communication interface 501 is capable of information exchange with another terminal and/or a network side.

The processor 502 is connected to the communication interface 501 to realize information exchange with another terminal and/or the network side for executing the method provided by the above one or more technical solutions when running a computer program.

The memory 503 has the computer program thereon.

In particular, when the sending end includes the network side, the processor 502 is configured to: measure, by the communication interface 501 in a cell selected to camp on by the terminal 500 after completing cell selection or reselection in cells configured with a first signal or channel, signal qualities or signal strengths of a current serving cell. The measurement includes measurement based on the first signal or channel and measurement based on an inherent measurement resource of a serving cell. At least one transmission signal or channel of the first signal or channel has a correspondence with at least one transmission signal or channel of the inherent measurement resource of the serving cell. The processor 502 is configured to: in a case that a detection result of at least one transmission signal or channel in the at least one transmission signal or channel of the first signal or channel meets a first condition, select, from the at least one transmission signal or channel of the first signal or channel, a transmission signal or channel with the best signal quality or the best signal strength as a detection target. The processor 502 is configured to: in a case that a detection result of none of the at least one transmission signal or channel of the first signal or channel meets the first condition, perform cell camping and/or screen out a target transmission signal or channel of the inherent measurement resource by measuring the at least one transmission signal or channel of the inherent measurement resource of the serving cell. The first condition represents one of: a transmission signal or channel of the first signal or channel is detected; a detected power of the transmission signal or channel is greater than or equal to a first threshold; a detected quality of the transmission signal or channel is greater than or equal to a second threshold; the detected power of the transmission signal or channel is greater than the first threshold; or the detected quality of the transmission signal or channel is greater than the second threshold.

In an embodiment, the processor 502 is further configured to: in a case that a received signal strength of the selected transmission signal or channel does not meet a third threshold and/or a received signal quality of the selected transmission signal or channel does not meet a fourth threshold, detect or monitor at least one transmission signal or channel corresponding to the inherent measurement resource, and/or detect or monitor the scheduling signal, and not detect the at least one transmission signal or channel of the first signal of the serving cell.

Alternatively, the processor 502 is further configured to: in a case that the received signal strength of the selected transmission signal or channel meets a fifth threshold and/or the received signal quality of the selected transmission signal or channel meets a sixth threshold, detect a transmission signal or channel of the first signal corresponding to a transmission signal or channel of the inherent measurement resource of the serving cell, and determine, based on a detection result, whether detection or monitoring for transmission signals or channels of the inherent transmission resource of the serving cell, and/or the detection or monitoring for the scheduling signal are needed.

When the sending end includes a terminal in a terminal-to-terminal link, the processor 502 is configured to: complete terminal selection and selects to monitor a second terminal; measure, by the communication interface 501, signal qualities or signal strengths of the second terminal upon receiving first information from the second terminal through the communication interface 501. The first information indicates that the second terminal will transmit a second signal or channel, the measurement includes measurement based on the second signal or channel and measurement based on an inherent measurement resource from the second terminal, at least one transmission signal or channel of the second signal or channel has a correspondence with at least one different transmission signal or channel of an inherent measurement resource of the second terminal. The processor 502 is configured to: in a case that a detection result of at least one transmission signal or channel in the at least one transmission signal or channel of the second signal or channel meets a second condition, select, from the at least one transmission signal or channel of the second signal or channel, a transmission signal or channel with the best signal quality or the best signal strength as a detection target. The processor 502 is configured to: in a case that a detection result of none of the at least one transmission signal or channel of the first signal or channel meets the second condition, screen out a target transmission signal or channel of the inherent measurement resource by measuring the at least one transmission signal or channel of the inherent measurement resource of the second terminal. The second condition represents one of: a transmission signal or channel of the second signal or channel is detected; a detected power of the transmission signal or channel is greater than or equal to a seventh threshold; a detected quality of the transmission signal or channel is greater than or equal to an eighth threshold; the detected power of the transmission signal or channel is greater than the seventh threshold; or the detected quality of the transmission signal or channel is greater than the eighth threshold.

In an embodiment, the processor 502 is further configured to: in a case that a received signal strength of the selected transmission signal or channel does not meet a ninth threshold and/or a received signal quality of the selected transmission signal or channel does not meet a tenth threshold, detect or monitor at least one transmission signal or channel corresponding to the inherent measurement resource of the second terminal, and/or detect or monitor the scheduling signal, and not detect the at least one transmission signal or channel of the second signal of the second terminal.

Alternatively, the processor 502 is further configured to: in a case that the received signal strength of the selected transmission signal or channel meets an eleventh threshold and/or the received signal quality of the selected transmission signal or channel meets a twelfth threshold, detect a transmission signal or channel of the second signal corresponding to a transmission signal or channel of the inherent measurement resource of the second terminal, and determine, based on a detection result, whether detection or monitoring for transmission signals or channels of the inherent transmission resource of the second terminal, and/or the detection or monitoring for the scheduling signal are needed.

It should be noted that the specific processing procedures of the processor 502 and the communication interface 501 may be understood with reference to the above method.

Of course, in practical applications, various components in the terminal 500 are coupled together through a bus system 504. It may be understood that the bus system 504 is used for realizing the connection and communication between the components. Besides a data bus, the bus system 504 further includes a power bus, a control bus and a state signal bus. However, for clarity of description, the buses are all signed as the bus system 504 in FIG. 5.

The memory 503 in the embodiments of the disclosure is used to store various types of data to support the operation of the terminal 500. Examples of such data include any computer program for operation on terminal 500.

The method disclosed in above embodiments of the disclosure may be applied to the processor 502, or may be implemented by the processor 502. The processor 502 may be an integrated circuit chip, and has the capability of signal processing. During implementation, the various operations of in the above method may be completed by an integrated logic circuit in hardware form or instructions in software form in the processor 502. The above processor 502 may be a general-purpose processor, a Digital Signal Processor (DSP), or other programmable logic devices, discrete gates or transistor logic devices, discrete hardware components and so on. The processor 502 may implement or perform the various methods, operations or logic blocks disclosed in the embodiments of the disclosure. The universal processor may be a microprocessor or any conventional processor and the like. The operations of the methods disclosed in combination with the embodiments of the disclosure may be directly embodied as being performed and completed by a hardware decoding processor, or being performed and completed by a combination of hardware and software modules in a decoding processor. The soft modules may be located in a storage medium, and the storage medium is in the memory 503. The processor 502 reads information from the memory 503 to implement operations of the above methods in combination with the hardware.

In an exemplary embodiment, the terminal 500 may be implemented by one or more Application Specific Integrated Circuit (ASICs), DSPs, Programmable Logic Devices (PLDs), Complex Programmable Logic Devices (CPLDs), Field-Programmable Gate Arrays (FPGAs), general-purpose processors, controllers, Micro Controller Units (MCUs), Microprocessors, or other electronic elements, to execute the method above.

It may be understood that the memory 503 in the embodiments of the disclosure may be a volatile memory or a non-volatile memory, or may include both a volatile memory and a non-volatile memory. The non-volatile memory may be a Read Only Memory (ROM), a Programmable Read-Only Memory (PROM), an Erasable Programmable Read-Only Memory (EPROM) an Electrically Erasable Programmable Read-Only Memory (EEPROM), a Ferromagnetic Random Access Memory (FRAM), a Flash Memory, a magnetic surface memory, an optical disc, or a compact disk read only memory (CD-ROM), or may be a device containing one or a combination of those memories. The magnetic surface memory may be a hard disk memory or a tape memory. The volatile memory may be a random access memory (RAM), that is used as an external cache. By way of example but not limiting, many forms of RAMs are usable, for example a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM), and a Direct Rambus Random Access Memory (DRRAM). The memory described in the embodiments of the disclosure is intended to include but not limited to memories of these and any other suitable types.

In an exemplary embodiment, embodiments of the disclosure further provide a storage medium, namely a computer storage medium, in particular, a computer-readable storage medium, for example the memory 503 including a computer program. The computer program may be executed by the processor 502 of the terminal 500, to accomplish the operations of the above method. The computer-readable storage medium may be such as an FRAM, an ROM, a PROM, an EPROM, an EEPROM, a flash drive, a magnetic surface memory, an optical disc, or a CD-ROM.

It should be noted that “first”, “second”, etc. are used to distinguish similar objects, and do not necessarily describe a specific sequence or ranking order.

Additionally, the technical solutions disclosed herein may be arbitrarily without conflict.

Described above are merely preferred embodiments of the disclosure, and are not used to limit the scope of protection of the disclosure.

1. A method for detection, implemented by a terminal, the method comprising:
measuring, in a cell selected to camp on after completing cell selection or reselection in cells configured with a first signal or channel, signal qualities or signal strengths of a cell currently selected by the terminal, wherein the measurement comprises measurement based on the first signal or channel and/or measurement based on an inherent measurement resource of the cell currently selected by the terminal, wherein at least one transmission signal or channel of the first signal or channel has a correspondence with at least one transmission signal or channel of the inherent measurement resource of the cell currently selected by the terminal;
when a detection result of at least one transmission signal or channel in the at least one transmission signal or channel of the first signal or channel meets a first condition, selecting, from the at least one transmission signal or channel of the first signal or channel, a transmission signal or channel with the best signal quality or the best signal strength as a detection target; and
when a detection result of none of the at least one transmission signal or channel of the first signal or channel meets the first condition, performing cell camping and/or screening out a target transmission signal or channel of the inherent measurement resource by measuring the at least one transmission signal or channel of the inherent measurement resource of the cell currently selected by the terminal;
wherein the first condition represents one of:
a transmission signal or channel of the first signal or channel is detected;
a detected power of the transmission signal or channel is greater than or equal to a first threshold;
a detected quality of the transmission signal or channel is greater than or equal to a second threshold;
the detected power of the transmission signal or channel is greater than the first threshold; or
the detected quality of the transmission signal or channel is greater than the second threshold.

2. The method of claim 1, wherein
the inherent measurement resource comprises signals and/or channels that are usable for measurement of the terminal and have to be sent when a network side is capable of providing a service for the terminal.

3. The method of claim 2, wherein the inherent measurement resource comprises one of:
a reference signal for synchronization in a system;
a reference signal and/or channel for synchronization and primary system information indication in the system; or
a reference signal configured by the system and usable for idle-state measurement.

4. The method of claim 1, wherein
one of the at least one transmission signal or channel of the first signal or channel has a Quasi Co-Location (QCL) relationship with at least one of the at least one transmission signal or channel of the inherent measurement resource.

5. The method of claim 1, wherein
the first signal or channel is used for the terminal to perform detection after camping on a cell and to determine, based on a detection result, whether subsequent monitoring or detection for transmission signals or channels of an inherent measurement resource of the cell camped on, and/or subsequent detection or monitoring for a scheduling signal are needed.

6. The method of claim 5, wherein
when at least one transmission signal or channel in the at least one transmission signal or channel of the first signal or channel meets the first condition, detection for any transmission signal or channel of the inherent measurement resource, and/or the detection or monitoring for the scheduling signal are not needed; or
when none of the at least one transmission signal or channel of the first signal or channel meets the first condition, the detection for the transmission signals or channels of the inherent measurement resource, screening for the at least one transmission signal or channel of the inherent measurement resource, and/or the detection or monitoring for the scheduling signal are needed.

7. The method of claim 1, wherein
when a received signal strength of the selected transmission signal or channel does not meet a third threshold and/or a received signal quality of the selected transmission signal or channel does not meet a fourth threshold, detection or monitoring for at least one transmission signal or channel corresponding to the inherent measurement resource, and/or the detection or monitoring for the a scheduling signal are needed, and detection for at least one transmission signal or channel of the first signal of the cell currently selected by the terminal is not needed; or
when the received signal strength of the selected transmission signal or channel meets a fifth threshold and/or the received signal quality of the selected transmission signal or channel meets a sixth threshold, a transmission signal or channel of the first signal corresponding to a transmission signal or channel of the inherent measurement resource of the cell currently selected by the terminal is detected, and it is determined, based on a detection result, whether detection or monitoring for transmission signals or channels of the inherent measurement resource of the cell currently selected by the terminal, and/or the detection or monitoring for the scheduling signal are needed.

8. The method of claim 7, wherein at least one of the following applies:
the third threshold is same as or different from the fifth threshold; or
the fourth threshold is same as or different from the sixth threshold.

9. A method for detection, implemented by a first terminal, the method comprising:
completing terminal selection and selecting to monitor a second terminal;
measuring signal qualities or signal strengths of the second terminal upon receiving first information from the second terminal, wherein the first information indicates that the second terminal will transmit a second signal or channel, the measurement comprises measurement based on the second signal or channel and/or measurement based on an inherent measurement resource from the second terminal, at least one transmission signal or channel of the second signal or channel has a correspondence with at least one transmission signal or channel of the inherent measurement resource of the second terminal;
when a detection result of at least one transmission signal or channel in the at least one transmission signal or channel of the second signal or channel meets a second condition, selecting, from the at least one transmission signal or channel of the second signal or channel, a transmission signal or channel with the best signal quality or the best signal strength as a detection target; and
when a detection result of none of the at least one transmission signal or channel of a first signal or channel meets the second condition, screening out a target transmission signal or channel of the inherent measurement resource by measuring the at least one transmission signal or channel of the inherent measurement resource of the second terminal;
wherein the second condition represents one of:
a transmission signal or channel of the second signal or channel is detected;
a detected power of the transmission signal or channel is greater than or equal to a seventh threshold;
a detected quality of the transmission signal or channel is greater than or equal to an eighth threshold;
the detected power of the transmission signal or channel is greater than the seventh threshold; or
the detected quality of the transmission signal or channel is greater than the eighth threshold.

10. The method of claim 9, wherein the inherent measurement resource comprises one of:
a reference signal for synchronization in a terminal-to-terminal link;
a reference signal and/or channel for synchronization and primary system information indication in the terminal-to-terminal link; or
a reference signal configured by a system and usable for idle-state measurement.

11. The method of claim 9, wherein
one of the at least one transmission signal or channel of the second signal or channel has a Quasi Co-Location (QCL) relationship with at least one of the at least one transmission signal or channel of the inherent measurement resource.

12. The method of claim 9, wherein
the second signal or channel is used for the first terminal to perform detection after performing terminal selection and to determine, based on a detection result, whether subsequent monitoring or detection for transmission signals or channels of an inherent measurement resource of the second terminal, and/or subsequent detection or monitoring for a scheduling signal are needed.

13. The method of claim 12, wherein
when at least one transmission signal or channel in the at least one transmission signal or channel of the second signal or channel meets the second condition, detection for any transmission signal or channel of the inherent measurement resource, and/or the detection or monitoring for the scheduling signal are not needed; or
when none of the at least one transmission signal or channel of the second signal or channel meets the second condition, the detection for the transmission signals or channels of the inherent measurement resource, screening for the at least one transmission signal or channel of the inherent measurement resource, and/or the detection or monitoring for the scheduling signal are needed.

14. The method of claim 9, wherein
when a received signal strength of the selected transmission signal or channel does not meet a ninth threshold and/or a received signal quality of the selected transmission signal or channel does not meet a tenth threshold, detection or monitoring for at least one transmission signal or channel corresponding to the inherent measurement resource of the second terminal, and/or detection or monitoring for a scheduling signal are needed, and detection for the at least one transmission signal or channel of the second signal of the second terminal is not needed; or
when the received signal strength of the selected transmission signal or channel meets an eleventh threshold and/or the received signal quality of the selected transmission signal or channel meets a twelfth threshold, a transmission signal or channel of the second signal corresponding to a transmission signal or channel of the inherent measurement resource of the second terminal is detected, and it is determined, based on a detection result, whether detection or monitoring for transmission signals or channels of the inherent measurement resource of the second terminal, and/or the detection or monitoring for the scheduling signal are needed.

15. The method of claim 14, wherein at least one of the following applies:
the ninth threshold is same as or different from the eleventh threshold; or
the tenth threshold is same as or different from the twelfth threshold.

16. (canceled)

17. (canceled)

18. A terminal, comprising a processor and a communication interface, wherein
the processor is configured to measure, in a cell selected to camp on by the terminal after completing cell selection or reselection in cells configured with a first signal or channel, signal qualities or signal strengths of a cell selected by the terminal, wherein the measurement comprises measurement based on the first signal or channel and/or measurement based on an inherent measurement resource of the cell currently selected by the terminal, wherein at least one transmission signal or channel of the first signal or channel has a correspondence with at least one transmission signal or channel of the inherent measurement resource of the cell currently selected by the terminal; and when a detection result of at least one transmission signal or channel in the at least one transmission signal or channel of the first signal or channel meets a first condition, select, from the at least one transmission signal or channel of the first signal or channel, a transmission signal or channel with the best signal quality or the best signal strength as a detection target; and when a detection result of none of the at least one transmission signal or channel of the first signal or channel meets the first condition, perform cell camping and/or screen out a target transmission signal or channel of the inherent measurement resource by measuring the at least one transmission signal or channel of the inherent measurement resource of the cell currently selected by the terminal; wherein the first condition represents one of:
a transmission signal or channel of the first signal or channel is detected;
a detected power of the transmission signal or channel is greater than or equal to a first threshold;
a detected quality of the transmission signal or channel is greater than or equal to a second threshold;
the detected power of the transmission signal or channel is greater than the first threshold.

19. (canceled)

20. (canceled)

21. The terminal of claim 18, wherein the inherent measurement resource comprises signals and/or channels that are usable for measurement of the terminal and have to be sent when a network side is capable of providing a service for the terminal.

22. The terminal of claim 18, wherein
one of the at least one transmission signal or channel of the first signal or channel has a Quasi Co-Location (QCL) relationship with at least one of the at least one transmission signal or channel of the inherent measurement resource.

23. The terminal of claim 18, wherein
the first signal or channel is used for the terminal to perform detection after camping on a cell and to determine, based on a detection result, whether subsequent monitoring or detection for transmission signals or channels of an inherent measurement resource of the cell camped on, and/or subsequent detection or monitoring for a scheduling signal are needed.

24. The terminal of claim 18, wherein
when a received signal strength of the selected transmission signal or channel does not meet a third threshold and/or a received signal quality of the selected transmission signal or channel does not meet a fourth threshold, detection or monitoring for at least one transmission signal or channel corresponding to the inherent measurement resource, and/or detection or monitoring for a scheduling signal are needed, and detection for at least one transmission signal or channel of the first signal of the cell currently selected by the terminal is not needed; or
when the received signal strength of the selected transmission signal or channel meets a fifth threshold and/or the received signal quality of the selected transmission signal or channel meets a sixth threshold, a transmission signal or channel of the first signal corresponding to a transmission signal or channel of the inherent measurement resource of the cell currently selected by the terminal is detected, and it is determined, based on a detection result, whether detection or monitoring for transmission signals or channels of the inherent measurement resource of the cell currently selected by the terminal, and/or the detection or monitoring for the scheduling signal are needed.
